(19) United States
(12) Patent Application Publication
(10) Pub. No.: US 2003/0044678 A1
(43) Pub. Date: Mar. 6, 2003

(54) Polymer battery that also serves as a durable housing for portable electronic devices and microchips

(76) Inventor: Tyson Winarski ESq., Tempe, AZ (US)

Correspondence Address: TYSON YORK WINARSKI, 428 EAST SUSAN LANE, TEMPE, AZ, 85281, US

(21) Appl. No.: 09/682,371

(22) Filed: Aug. 25, 2001

(51) Int. Cl. H01M 10/40; H01M 4/52; H01M 4/66; H01M 4/62

(52) U.S. Cl. 429/162; 429/231.3; 429/232; 429/309; 429/245; 429/303

(57) ABSTRACT

A plastic structural casing, having a base and four electrically and structurally contiguous sidewalls, is formed using a single plastic battery. This base and contiguous sidewalls form a cavity wherein those electrical components which draw power from the plastic battery can be housed. Thus, the one structural casing simultaneously provides the functions of (a) mechanical durability, strength, and structural integrity to house electrical components as well as (b) delivers direct current (DC) electrical power to those same electrical components. A cover, which may also be a plastic battery, is used to seal this cavity from external contamination.

### BACKGROUND OF INVENTION

This application hereby incorporates by reference two United States patents. The first is U.S. Pat. No. 6,165,645 which was issued to Nishimura et-al on Dec. 26, 2000 and entitled Polymer Electrolyte and Lithium Polymer Battery using the Same. The second is U.S. Pat. No. 5,645,960 which was issued to Scrosati et-al on Jul. 8, 1997 and entitled Thin Film Lithium Polymer Battery.

The present invention relates to the field of polymer batteries and more specifically to polymer batteries having sufficient mechanical durability, strength, and structural integrity to additionally form a housing for electronics. These polymer batteries may also be called plastic batteries. However, the term polymer batteries will be used for consistency.

Portable electronic devices have provided individuals with an unparalleled degree of personal freedom. Laptop computers, pagers, palm pilots, portable radios, and portable CD-ROM (compact disk, read only memory) and DVD (digital versatile disk) players have revolutionized an individual's mobility. In order to function, each portable electronic device requires a mobile power source, a battery. Today's portable electronic devices are typically powered using rechargeable battery packs made of conventional Lithium, NiCad, or NiMH batteries. The only disadvantage to Lithium-Ion batteries is that they are currently more expensive than NiCad and NiMH battery packs.

Lithium batteries are commonly used due to the fact that Lithium is the lightest metal and the metal that has the highest electrochemical potential, +3.045 volts at 25C. Lithium, however, is an unstable metal, so Lithium-Ion batteries are made from chemically-induced ionized-Lithium (does this sound better than what you said?). Because of its lightness and high energy density, Lithium-Ion batteries are ideal for portable devices, such as portable computers. In addition, Lithium-Ion batteries have no memory effect and do not use poisonous heavy-metals, such as lead, mercury or cadmium.

NiCad stands for nickel-cadmium, the materials used in the battery packs for many portable computers. NiCad batteries can provide considerable power, but they need to be recharged every three or four hours. Full recharging can take as much as twelve hours, although newer batteries can be recharged in just a few hours. Older NiCad batteries suffer from a phenomenon known as the memory effect. If they were only partially drained and then recharged, they lost their capacity to be fully charged. This is not such a problem with modern NiCad batteries. Even with full drainage (called deep discharging), all batteries have a limit to the number of times they can be recharged. The maximum for most NiCad batteries is about one thousand recharges.

NiMH stands for Nickel-Metal Hydride , the materials used in some battery packs. Unlike NiCad batteries, NiMH batteries do not use heavy metals that may have toxic effects. In addition, they can store up to 50% more power than NiCad batteries and do not suffer from memory effects.

Batteries consist of three components: an anode (the positive electrode), a cathode (the negative electrode), and an electrolyte (the conductive material between the electrodes, such as the liquid in a car battery). In conventional batteries such as Lithium-Ion, NiCad, or NiMH batteries, the electrodes are made of a metal and the electrolyte is made of a conducting liquid. In an all-polymer battery, both of the electrodes and the electrolyte are made of polymers. All polymer batteries are significantly lighter in weight than conventional Lithium-Ion, NiCad, or NiMH batteries. In addition, this power cell's unusual thin sandwich design makes it highly adaptable. The anode and cathode are made of thin, foil-like plastic sheets. The electrolyte is a polymer gel film placed between the electrodes, holding the battery together. One current configuration for an all-polymer battery has a layer of polytetrafluoroethylene, also known by the tradename TEFLON, supporting a carbon current collector layer. Below the carbon current-collector layer is a layer of poly 3, 4, 5 TFPT that serves as the anode. TFPT is trifluorophenylthiophene. A layer of poly 3, 5 DFPT serves as the cathode below the anode. DFPT is difluorophenylthiophene. Between the anode and cathode is a polymer gel electrolyte. Another layer of carbon current collector is placed below the cathode and is supported by another layer of Teflon.

In addition, polymer batteries exist that have high mechanical strength. The U.S. Pat. No. 6,165,645 issued to Nishimura et al. discloses a gelled polymer electrolyte having a high mechanical strength and a high ion conductivity and a lithium polymer battery using the same electrolyte. The gelled polymer electrolyte comprises a polymer alloy and an organic electrolyte solution, wherein the polymer alloy includes a polymer which is hardly soluble in the organic electrolyte solution and another polymer which is soluble in the organic electrolyte solution. The lithium polymer battery comprises a negative electrode including metallic lithium, a lithium alloy, carbon or an inorganic compound, and a positive electrode including an active material of a metal oxide capable of intercalating and deintercalating lithium in a reversible manner, such as LiCoO₂, LiNiO₂ or the like, and the gelled polymer electrolyte placed between both electrodes.

Unlike nickel-cadmium rechargeable batteries, all-polymer batteries contain no heavy metals, which can contaminate soil and water. The all-polymer batteries also contain no liquids, which can leak and pose safety hazards. In addition, the all-polymer battery operates efficiently in extreme heat or cold. The electrical producing properties of many conventional battery materials vary with temperature. For example, car batteries typically have difficulty under extreme cold temperatures. However, polymer batteries are capable of operating at temperatures far below conventional metal-electrode batteries without any change in electrical properties.

Due to their design, it is impractical to utilize Lithium-Ion, NiCad, or NiMH batteries as a structural component to a device. While polymer batteries are known in the current state of the art for their ability to produce electricity, currently the ability of polymer batteries to provide structural support to the devices they power is unknown in the art.

Another electrical component that requires power is volatile memory. Volatile memories lose their data when power is shut off. Dynamic RAM (random access memory) is a common form of volatile memory. RAM is a type of computer memory that can be accessed randomly; that is, any byte of memory can be accessed without touching the preceding bytes. RAM is the most common type of memory found in computers and other devices, such as printers. There are two basic types of RAM: Dynamic RAM (DRAM) and Static RAM (SRAM). Dynamic RAM needs to be refreshed thousands of times per second. Static RAM does not need to be refreshed, which makes it faster; but it is also more expensive than dynamic RAM. Both DRAM and SRAM are comprised of electrical circuits that are formed on microchips.

The power required to refresh volatile memories is minimal. It is possible to refresh DRAM data using batteries. The use of conventional batteries to refresh volatile memories is well known and such batteries exist in many varieties. However, the current state of the art does not disclose a method of using a durable plastic housing to both physically protect the memory microchip and additionally provide a backup battery power source for that memory chip.

To summarize, all portable electric devices are protected by a durable polymer housing. In addition, all microchips, including the ones for DRAM, are protected by a durable polymer housing. Currently, the durable polymer housings for portable electric devices and microchips only provide structural support and protection. It is currently unknown to provide a durable polymer housing that also serves as an electrical power source.

### SUMMARY OF INVENTION

The object of the present invention is to provide a durable housing for portable electronic devices and for microchips that also serves as a power source. More specifically, this invention discloses the use of polymer batteries to form the durable polymer housing for portable electronic devices and for microchips.

Batteries have three key design parameters for portable devices. Weight is a key design parameter. Customers did not want to lug a thirty-pound laptop computer through an airport, so the race has been going on to produce lighter laptops ever since the first luggable personal computers were made in the early 1980's. Size is another key parameter. Shrinking an electrical device's size enhances its portability. Today, the most expensive and sought after portable phones are the ones that have the smallest physical dimensions. As the size of the portable device shrinks, so must the power source. Still another key design parameter is power. While the size of batteries is shrinking, consumer demand for more device functions and longer lifetime require increasing the lifetime and power provided by batteries.

At present, all portable electronic devices are protected and supported by a durable polymer shell. It is possible to meet consumer desires for low weight, small, well powered portable electric devices through replacing existing durable polymer housings that store no electrical charge with durable polymer housings that are made from polymer batteries. Polymer batteries are lighter in weight than existing conventional batteries that have metal electrodes. Converting the space occupied by existing durable polymer housings that store no electrical charge into polymer batteries greatly increases the volume available for power storage. This conversion enables smaller portable electronic devices to have enhanced capabilities and endurance.

As noted earlier, microchips are currently protected by a durable polymer housing that stores no electrical power. The present invention discloses the use of forming the durable polymer housing to microchips out of polymer batteries thereby turning the durable housing into a power source. The object of this invention is to provide a durable polymer housing for DRAM and SRAM microchips that functions as a backup power supply in addition to providing structural support and protection.

Further objects and advantages of the invention will become apparent as the following description proceeds and the features of novelty which characterize this invention are pointed out with particularity in the claims annexed to and forming a part of this specification.

### BRIEF DESCRIPTION OF DRAWINGS

The novel features that are considered characteristic of the invention are set forth with particularity in the appended claims. The invention itself; however, both as to its structure and operation together with the additional objects and advantages thereof are best understood through the following description of the preferred embodiment of the present invention when read in conjunction with the accompanying drawings wherein:

FIG. 1 shows a polymer battery (prior art);

FIG. 2 shows a polymer battery (prior art);

FIG. 3 shows a view and a cutout section view of a cellular phone having a durable polymer structural casing formed from a polymer battery; FIG. 3A shows a sectional view of the cellular phone casing;

FIG. 4 shows a view and two cutout section views of a portable computer having a durable polymer structural casing formed from a polymer battery; FIG. 4A shows a sectional view of the laptop computer casing; FIG. 4B shows a sectional view of the laptop computer casing;

FIG. 5 shows a view and a cutout section view of a microchip having a durable polymer structural casing formed from a polymer battery; FIG. 5A shows a sectional view of the microchip casing;

FIG. 6 shows view and a cutout section view of a camera having a durable polymer structural casing formed from a polymer battery; FIG. 6A shows a sectional view of the camera casing;

FIG. 7 shows a cross-section view of a durable polymer structural casing formed from a polymer battery, showing four structurally and electrically contiguous sidewalls;

FIG. 8 shows two halves of a durable polymer structural casing, at least one formed from a polymer battery, showing two sidewalls on each half; and

FIG. 9 shows two halves of a durable polymer structural casing, at least one formed from a polymer battery, showing one sidewall on one half and three sidewalls on the other half.

### DETAILED DESCRIPTION

While the invention has been shown and described with reference to a particular embodiment thereof, it will be understood to those skilled in the art, that various changes in form and details may be made therein without departing from the spirit and scope of the invention.

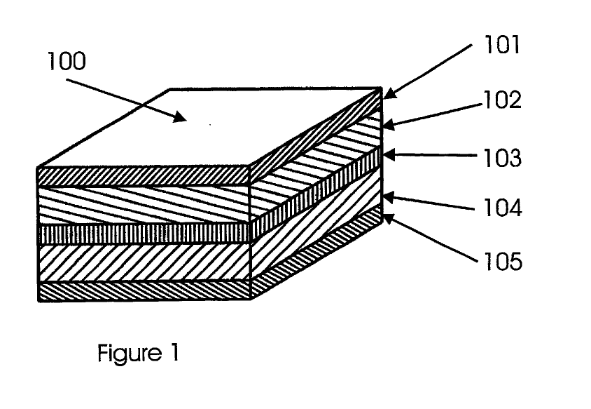

FIG. 1 shows a prior art polymer battery 100 from U.S. Pat. No. 6,165,645. Negative electrode layer 102 is configured by adhering a metallic lithium to a negative electrode current collector layer 101. Positive electrode layer 104 is configured by applying a paste composed of LiCoO₂, acetylene black, and a binder to a positive electrode current collector layer 105. Between both electrodes, gelled electrolyte layer 103 is inserted, to obtain a lithium polymer battery. As depicted in prior art FIG. 1, all layers are flat parallel planes.

The quantity of polyethylene oxide is preferably between 25% and 60% by weight. This provides a tensile strength between 400 to 100 kilograms-force per square centimeter, where the tensile strength decreases as the weight percentage of polyethylene increases. Given that 1 kilogram-force is 2.2 pounds-force and that there are 2.54 centimeters per inch, 1 kilogram-force per square centimeter is equal to approximately 14.2 pounds per square inch (psi). This gives a tensile strength in the range of 5,680 psi to 1,420 psi, which is sufficiently high to provide mechanical durability, strength, and structural integrity to form a housing for electronics, in addition to providing power to those same electronics.

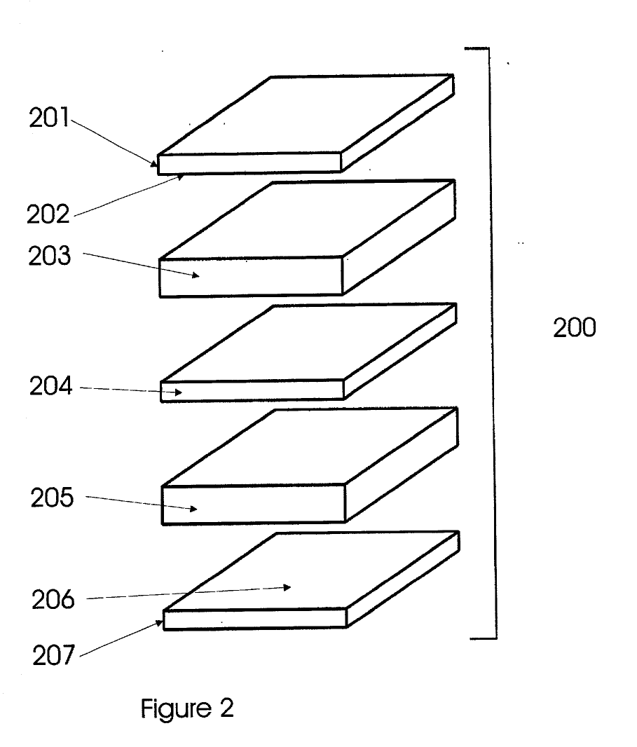

FIG. 2 shows an alternate prior art polymer battery 200 that was disclosed in an article entitled “An all polymer charge storage device” authored by Yossef Gofer, Haripada Sarker, Jeffrey G. Killian, Theodore O. Poehler, and Peter C. Searson and published in Appl. Phys. Lett. (USA) Vol.71, No.11, September 15, 1997, pages 1582-1584. Teflon support 201 has carbon current collector 202 on an inner surface. Carbon current collector 202 is in contact with poly-3,4,5 TFPT (trifluorphenylthiophene) anode 203. Polymer gel layer 204 is sandwiched between anode 203 and poly-3,5 DFPT (difluorophenylthiophene) cathode 205. Polymer gel layer 204 may be approximately 1 mm thick, or thicker, depending on the application. Finally, Teflon support 207 has carbon current collector 206 on an inner surface. Carbon current collector 206 is in contact with cathode 205. Polymer battery 200 is rechargeable and can be manufactured in thin, flat shapes, as opposed to the bulky and cylindrically-shaped common batteries used in flashlights, television remotes, etc. Teflon supports 201 and 207 provide mechanical durability, strength, and structural integrity. Thus, polymer battery 200 exhibits the same propensity to be used as a structural member as polymer battery 100.

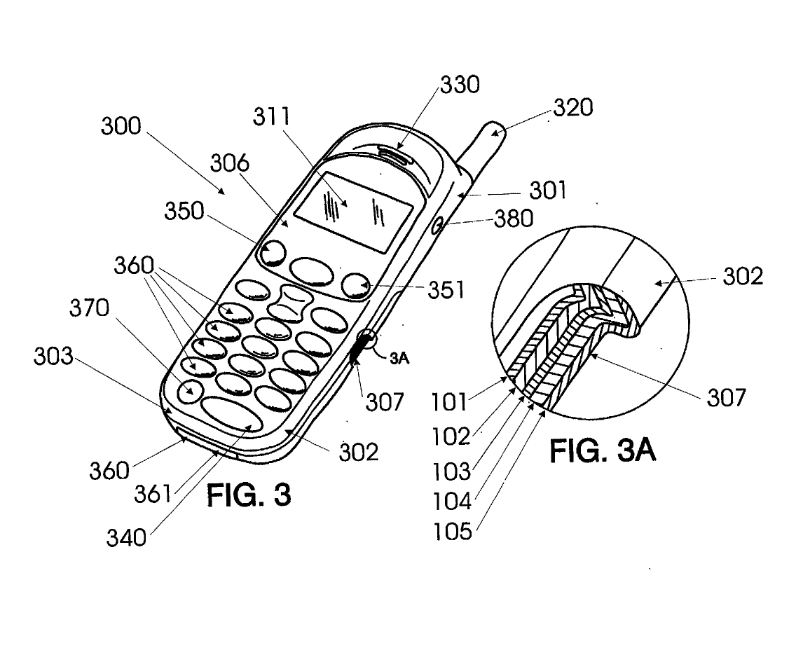

Polymer batteries 100 and 200 are shown as exemplary examples of the art. In Comparing FIGS. 1 and 2, carbon current collector 202 corresponds to positive electrode current collector layer 105, poly-3,4,5 TFPT anode 203 corresponds to positive electrode layer 104, polymer gel layer 204 corresponds to gelled electrolyte layer 103, poly-3,5 DFPT cathode 205 corresponds to negative electrode layer 102, carbon current collector 206 corresponds to negative electrode current collector layer 107. However, the invention is not limited to these specific polymeric batteries and, in fact, any polymeric battery with sufficient mechanical durability, strength, and structural integrity may be used as shown in FIGS. 3 through 9.

FIG. 3 shows cellular phone 300 having a durable polymer structural casing 301 formed from a polymer battery. This polymer battery could be layers 101-105 as shown in FIG. 1, layers 201-207 as shown in FIG. 2, or any similar polymer battery. Structural casing 301 preferably includes a base 307 and four structurally and electrically contiguous side walls. Two of these sidewalls, 302 and 303, are shown in FIG. 3. The base and four contiguous sidewalls form a cavity which encloses the electronics of cellular telephone 300. In the cutout section of FIG. 3, shown in FIG. 3A, positive electrode current collector layer 105 is shown as the outermost layer of the polymer battery, and the inward progression of layers is 104, 103, 102, and ending with negative electrode current collector layer 101 as the inner most layer. However, the ordering of these layers could be reversed for a given design, with negative electrode current collector layer 101 as the outermost layer of the polymer battery, and the inward progression of layers would then be 102, 103, 704, and ending with positive electrode current collector layer 105 as the inner most layer. Either way, cover 306 seals this cavity from external contamination.

Cover 306 may also be formed from a polymer battery. If cover 306 is indeed formed from a polymer battery, then cover 306 could be electrically connected to structural casing 301 in two ways, either in parallel or serially. Cover 306 would increase the current capacity by being connected in parallel to structural casing 301. However, cover 306 would increase the voltage capacity by being connected in series to structural casing 301.

Cover 306 supports display 311, which is preferably an LCD (liquid crystal display). An LCD uses organic fluids called liquid crystals, because liquid crystals possess two important properties. First, liquid crystals are transparent but can alter the orientation of polarized light passing through them. Second, the alignment of liquid crystal molecules and their polarization properties can be changed by applying an electric field. Liquid crystals are sandwiched between two glass plates, the outsides of which having been coated with polarizing filters and the inner plate is typically backlit via fluorescent light. Inside these glass plates is a matrix of electrodes. When an element of the matrix, called a pixel, experiences a voltage change, the polarization of the adjacent liquid crystal molecules change, which alters the light transmitted through the LCD pixel and hence seen by the user. However, display 311 could also be a LED (light emitting diode) display or an electroluminescent display.

Cover 306 may have holes through which a plurality of push-button keys protrude specifically for user input. Push-button keys 360 are the 1, 2, 3, 4, 5, 6, 7, 8, 9, and 0 keys commonly used for dialing phone numbers, as well as the well known * and # keys. Push-button keys 350, 351, and 370 are typically special function keys, such as scroll keys for viewing information on LCD 311. All of these push-button keys are optional, as display 311 may have a touch screen feature capable of supporting user input.

Cover 306 has holes 340 which permit spoken sound to be received by a microphone (not shown) inside the aforementioned cavity for conversion into electrical signals for transmission by antenna 320. Cover 306 also has holes 330 which permit electrical signals received by antenna 320 and subsequently converted into sound by a speaker (not shown) inside the aforementioned cavity. Structural casing 301 would typically need either a slot or hole (not shown) cut in it to accommodate antenna 320.

The aforementioned cavity contains the electrical circuitry (not shown) which makes the conversion between sound and wireless communications per one of many possible standards. Europe and Asia currently use the GSM (Global Standard for Mobile communications) standard. Europe and Asia may switch in the future to W-CDMA (Wideband Code Division Multiple Access). In North America, CDMA (Code Division Multiple Access) networks may also migrate to W-CDMA. TDMA (Time Division Multiple Access) systems may migrate to EDGE (Enhanced Data rates for Global Evolution).

Cellular phone 300 has electrically conductive recharge contacts 360 and 361, for the purpose of recharging the polymer battery which comprises polymer structural casing 301. If cover 306 is also formed from a polymer battery, it would be recharged via the same contacts. A typical location for recharge contacts 360 and 361 would be on sidewall 303, so that cellular phone 300 would be recharged while standing in its recharger (not shown). However, recharge contacts 360 and 361 could be anywhere on cellular phone 300.

Cellular telephone 300 also has on/off switch 380. When switch 380 is on, cellular phone 300 is in an active state and capable of transmitting and receiving. This active state consumes battery power. However, when switch 380 is off, cellular phone 300 is in an inactive state and battery power is conserved.

The polymer battery which comprise structural casing 301 and possibly cover 306 provide the power for the microphone, speaker, display 311 and the circuitry to transmit and receive telephone conversations. Thus, the structural casing of cellular phone 300 simultaneously provides mechanical durability, strength, and structural integrity as well as electrical power.

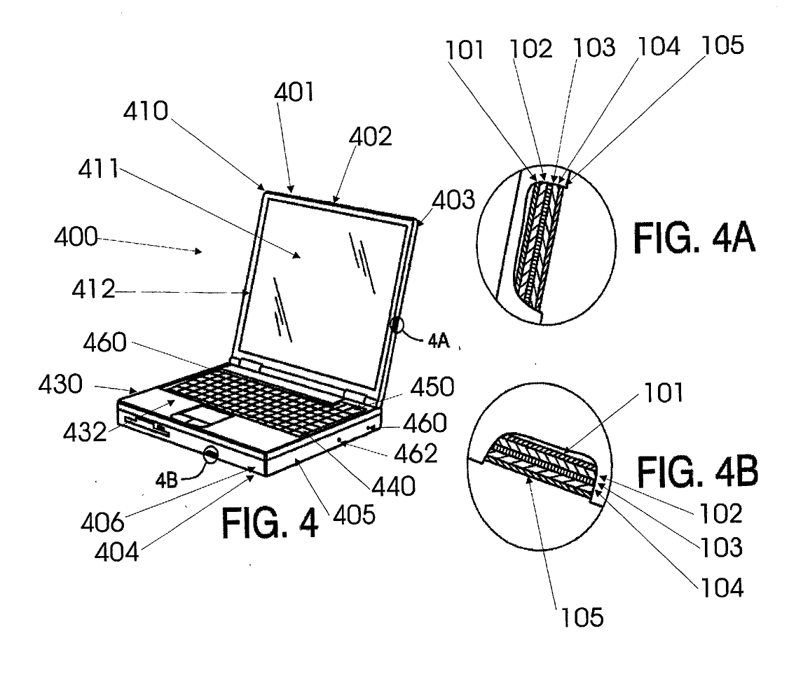

FIG. 4 shows portable computer 400 having upper polymer structural casing 410 and lower polymer structural casing 430 each formed from a polymer battery. Upper polymer structural casing 410 and lower polymer structural casing 430 are rotatably connected by one or more hinges 420. Computer 400 could be a common laptop. However, computer 400 could equally be a Palm-Pilot or other hand-held computer or calculator.

Each polymer battery could be layers 101-105 as shown in FIG. 1, layers 201-207 as shown in FIG. 2, or any similar polymer battery. Upper structural casing 410 preferably includes a base 401 and four structurally and electrically contiguous side walls. Two of these sidewalls, 402 and 403, are shown in FIG. 4. Base 401 and the four contiguous sidewalls form an upper cavity which encloses the display electronics of portable computer 400. Lower structural casing 430 preferably includes a base 404 and four structurally and electrically contiguous side walls. Two of these sidewalls, 405 and 406, are shown in FIG. 4. Base 404 and its four sidewalls form a lower cavity which encloses the calculating electronics of portable computer 400. In the cutout sections of FIG. 4, shown in FIGS. 4A and 4B, positive electrode current collector layer 105 is shown as the outermost layer of each polymer battery, and the inward progression of layers is 104, 103, 102, and ending with negative electrode current collector layer 101 as the inner most layer. However, the ordering of these layers could be reversed for a given design, with negative electrode current collector layer 101 as the outermost layer of either polymer battery, and the inward progression of layers would then be 102, 103, 104, and ending with positive electrode current collector layer 105 as the inner most layer. Either way, cover 412 seals the upper cavity and cover 432 seals the lower cavity from external contamination. Hinges 420 also contain wiring which allows electrical communication between the electronics in the upper and lower cavities.

Covers 412 and 432 may also be formed from polymer batteries. If covers 412 and 432 indeed formed from a polymer battery, then cover 412 could be electrically connected to structural casing 410 and cover 432 could be electrically connected to structural casing 430 either of two ways, in parallel or serially. A parallel connection would increase the current capacity and a serial connection would increase the voltage capacity.

Cover 412 supports display 411, which is preferably an LCD (liquid crystal display). However, display 411 could also be a LED (light emitting diode) display or an electroluminescent display.

Cover 432 may have holes through which a plurality of push-button keys protrude specifically for user input. Push-button keys 440 are the QWERTY keys commonly used for typing or keyboarding input. Push-button keys 460 are typically special function keys, such as F1, F2, through F12. Push-button keys 450 may be numeric keys 0, 1, 2, 3, 4, 5, 6, 7, 8, 9. All of these push-button keys are optional, as the display 411 may have a touch screen feature capable of supporting user input.

Recharging plug 460 is used for recharging the polymer batteries in portable computer 400. I/O port 462 can receive data from digital camera 600 or other device.

The polymer battery which comprise structural casings 410 and 430 as well as possibly covers 412 and 432 provide the power for display 411, as well as memory 500, a microprocessor (not shown), and any computer peripheral such as a hard disk drive (not shown) in one of the cavities in computer 400. Thus, the structural casings of computer 400 simultaneously provide mechanical durability, strength, and structural integrity as well as electrical power.

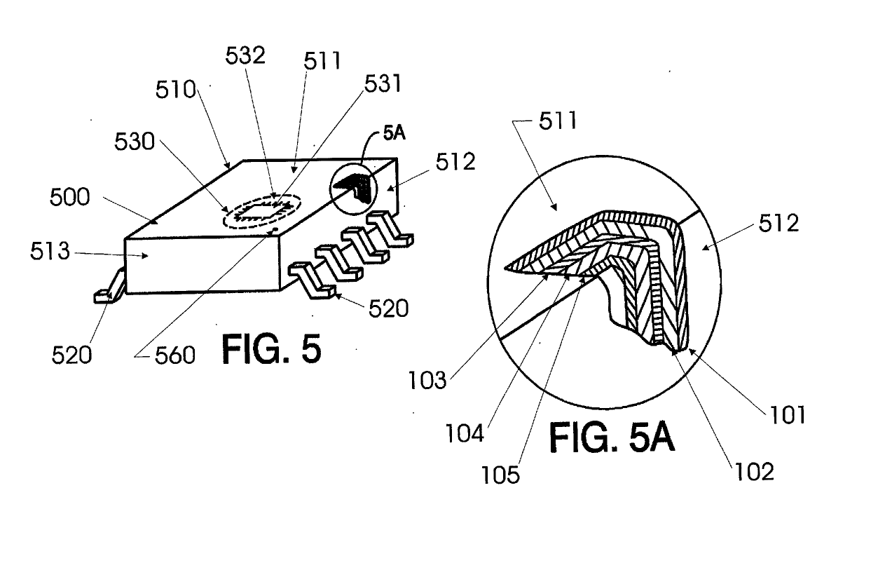

FIG. 5 shows microchip 500 having a durable polymer structural casing 510 formed from a polymer battery. This polymer battery could be layers 101-105 as shown in FIG. 1, layers 201-207 as shown in FIG. 2, or any similar polymer battery. Structural casing 510 preferably includes a top 511 and four structurally and electrically contiguous side walls. Two of these sidewalls, 512 and 513, are shown in FIG. 5. The base and four contiguous sidewalls form a cavity which encloses the electronics 531 of microchip 500. In the cutout section of FIG. 5, shown in FIG. 5A, negative electrode current collector layer 101 is shown as the outermost layer of the polymer battery, and the inward progression of layers are 102, 103, 104, and ending with positive electrode current collector layer 105 as the inner most layer. However, the ordering of these layers could be reversed for a given design, with positive electrode current collector layer 105 as the outermost layer of the polymer battery, and the inward progression of layers is 104, 103, 102, and ending with negative electrode current collector layer 101 as the inner most layer. Either way, a base (not shown) seals this cavity from external contamination.

Microchip 500 has a series of electrical contacts 520 emanating along the perimeter of its base. Electrical contacts 520 are used to provide power to and I/O to/from electronics 531 via wires 532. The proper orientation of microchip 500 on its circuit board (not shown) is provided for by identifier 560, which is typically a very shallow circular depression in one corner of the outer surface of top 511.

If microchip 500 is an EPROM (erasable, programmable read only memory) chip, electronics 531 may be visible through a sealed but optically transparent window 530. This window 530 allows the use of ultraviolet radiation to erase the currently stored microcode or data contents of electronics 531, so that they may be subsequently replaced by new microcode or data.

The polymer battery which comprise structural casing 510 provides the power or the backup power for electronics 530. Thus, the structural casing of microchip 500 simultaneously provides mechanical durability, strength, and structural integrity as well as electrical power.

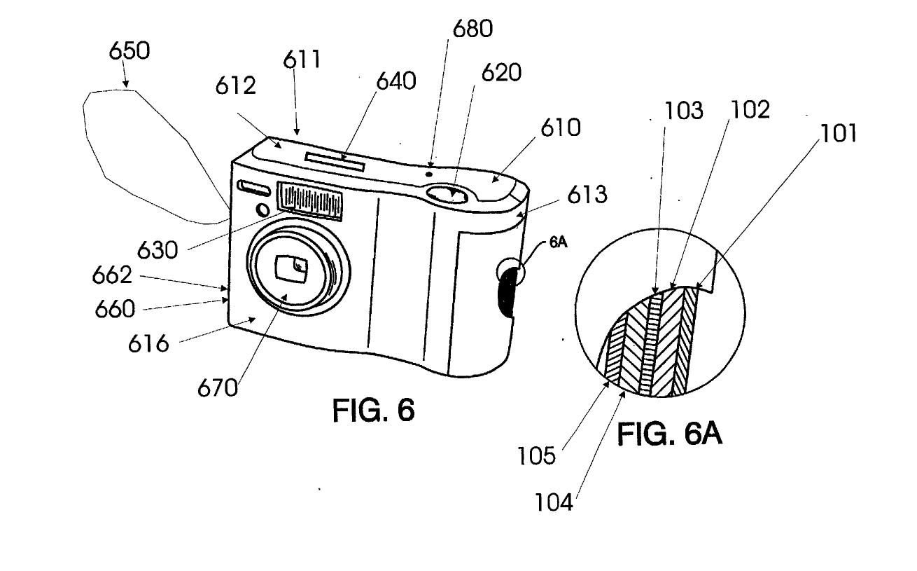

FIG. 6 shows camera 600 having a durable polymer structural casing 610 formed from a polymer battery. This polymer battery could be layers 101-105 as shown in FIG. 1, layers 201-207 as shown in FIG. 2, or any similar polymer battery. Structural casing 610 preferably includes a base 611 and four structurally and electrically contiguous side walls. Two of these sidewalls, 612 and 613, are shown in FIG. 6. The base and four contiguous sidewalls form a cavity which encloses the optics and electronics of camera 600. In the cutout section of FIG. 6, shown in FIG. 6A, positive electrode current collector layer 105 is shown as the outermost layer of the polymer battery, and the inward progression of layers is 104, 103, 702, and ending with negative electrode current collector layer 101 as the inner most layer. However, the ordering of these layers could be reversed for a given design, with negative electrode current collector layer 101 as the outermost layer of the polymer battery, and the inward progression of layers would then be 102, 103, 104, and ending with positive electrode current collector layer 105 as the inner most layer. Either way, cover 616 seals this cavity from external contamination.

Cover 616 may also be formed from a polymer battery. If cover 616 is indeed formed from a polymer battery, then cover 616 could be electrically connected to structural casing 610 in two ways, either in parallel or serially. Cover 616 would increase the current capacity by being connected in parallel to structural casing 610. However, cover 616 would increase the voltage capacity by being connected in series to structural casing 610.

Cover 616 supports optical lens 670. Light is focused by optical lens 670 onto either film (not shown) or a CCD (charge coupled device, not shown) inside the aforementioned cavity. If focused onto a CCD, the digital image may be stored in microchip 500 or other data storage device until eventually downloaded to a main data storage device such computer 400. This downloading would be done via download port 662.

Cover 616 has at least one hole, through which the light passes from optical lens 670 to either the film or CCD inside the aforementioned cavity. Optional flash unit 630 may also mounted on cover 616. Optional LCD 640 indicates how many remaining shots are available, the adequacy of the ambient lighting, etc.

Camera 600 has electrical recharge port 660, for the purpose of recharging the polymer battery which comprises polymer structural casing 610. If cover 616 is also formed from a polymer battery, it would be recharged via the same port. One possible location for recharge port 660 could be on sidewall 613. However, recharge port 660 could be anywhere on camera 600.

Camera 600 may also have on/off switch 680. When switch 680 is on, the camera is in an active state and capable of taking pictures when shutter button 620 is pressed. However, when switch 680 is off, the camera 600 is incapable of taking pictures should shutter button 620 be accidentally pressed. Camera 600 may have optional carrying strap 650.

The polymer battery which comprise structural casing 610 and possibly cover 616 provide the power for flash unit 630, memory 500, LCD 640 and, if used, the internal CCD. Thus, the structural casing of camera 600 simultaneously provides mechanical durability, strength, and structural integrity as well as electrical power.

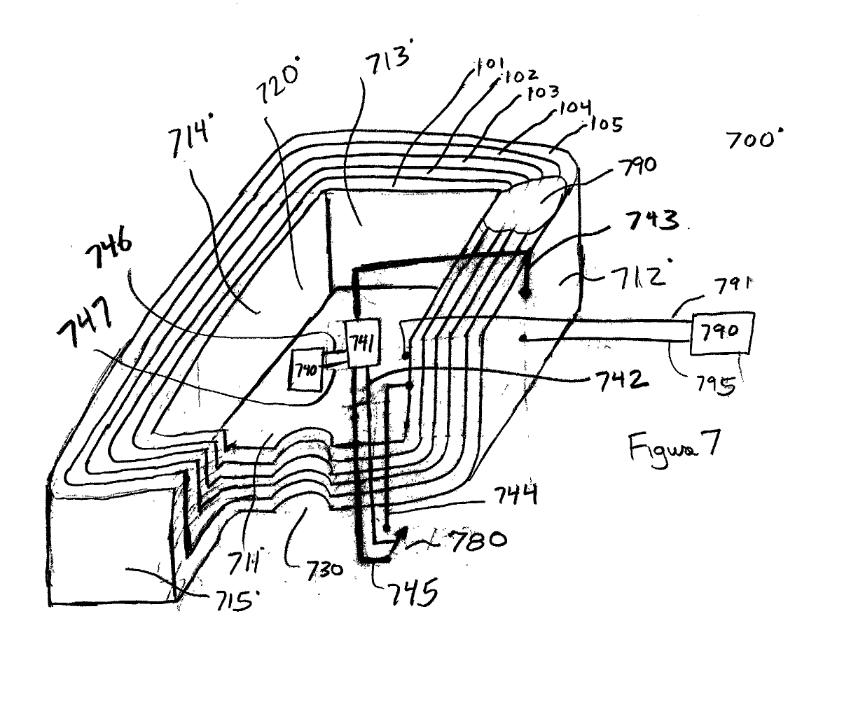

FIG. 7 shows a cross-section view of a durable polymer structural casing 700 formed from a polymer battery. This polymer battery could be layers 101-105 as shown in FIG. 1, layers 201-207 as shown in FIG. 2, or any similar polymer battery. Starting with the exterior layer of the polymer battery, succeeding interior layers are nested inside, until the final layer is reached. Structural casing 700 includes a base 711 and four structurally and electrically contiguous side walls 712, 713, 714, and 715. The interior surfaces of base 711 and the four contiguous sidewalls 712-715 form cavity 720 which encloses one or more electrical elements 740. Starting with the exterior layer, succeeding interior layers are nested inside, until the final layer is reached.

In FIG. 7, positive electrode current collector layer 105 is shown as the outermost layer of the polymer battery, and the inward progression of layers is 104, 103, 102, and ending with negative electrode current collector layer 101 as the inner most layer. However, the ordering of these layers could be reversed for a given design, with negative electrode current collector layer 101 as the outermost layer of the polymer battery, and the inward progression of layers would then be 102, 103, 104, and ending with positive electrode current collector layer 105 as the inner most layer.

The one or more electrical elements 740 are electrically connected to positive electrode current collector layer 105 and negative electrode current collector layer 101 via wires 743, 744, 745, 746, and 747. Thus, DC (direct current) may flow from the polymer battery which comprises durable polymer structural casing 700 and one or more electrical elements 740. One or more electrical elements 740 may include optional voltage regulator 747, to provide a uniform voltage to one or more electrical elements 740. In addition, optional on/off switch 780 may be available to turn power on or off to one or more electrical elements 740. On/off switch 780 is shown in the off position in FIG. 7. Optional DC voltage regulator 741 may turn on/off switch 780 to the off position via control line 742, should the remaining DC voltage in polymer structural casing 700 fall below a preset threshold for operation of one or more electrical elements 740, so that one or more electrical elements 740 are not damaged by insufficient DC voltage. If optional DC voltage regulator 741 is not present, then wires 743 and 746 are contiguous, wires 745 and 747 are contiguous, and control line 742 would not be present.

An example of optional voltage regulator 741 is off-the-shelf chips LM3712 and LM3713 by National Semiconductor. The LM3712/LM3713 series of microprocessor supervisory circuits provide the maximum flexibility for monitoring power supplies and battery controlled functions in systems. These chips include threshold detector for power fail warning.

Polymer structural casing 700 also shows the cross-section of hole 730 through battery layers 101-105. Hole 730 allows the connection of antenna 320, display 311, keys 360, etc. for cellular phone 300; LCD 411, keys 440, etc., for computer 400; sealed but optically transparent window 530, etc., for microchip 500; and optical lens 670, LCD 640, recharge port 660, etc., for camera 600. The presence of hole 730 does not compromise the ability of polymer structural casing 700 to simultaneously provide mechanical durability, strength, and structural integrity as well as DC electrical power. The exposed surface of hole 730, as well as all exposed surfaces of polymer structural casing 700, would be sealed by a conventional nonconductive polymeric or elastomeric compound 790, to protect the electric storage capabilities of polymeric structural casing 700. Examples of a conventional nonconductive polymeric compound include polycarbonate, polytetrafluoroethylene (commonly known by the trade name of TEFLON), and acrylic.

The recharge of the polymer battery would use controller 790 and line 791, which is connected to layer 101, and line 795, which is connected to layer 105. Controller 790 would then be connected to external power (not shown). An example of a recharge controller is the LM3420 series of controllers by National Semiconductor.

These LM3420 controllers are monolithic integrated circuits designed for charging and end-of-charge control for Lithium-Ion rechargeable batteries. The LM3420 is available in five fixed voltage versions for one through four cell charger applications (4.2V, 8.2V/8.4V, 12.6V and 16.8V respectively). Included in a very small package is an (internally compensated) op amp, a bandgap reference, an NPN output transistor, and voltage setting resistors. The amplifier's inverting input is externally accessible for loop frequency compensation. The output is an open-emitter NPN transistor capable of driving up to 15 mA of output current into external circuitry. A trimmed precision bandgap reference utilizes temperature drift curvature correction for excellent voltage stability over the operating temperature range. Available with an initial tolerance of 0.5% for the A grade version, and 1% for the standard version, the LM3420 allows for precision end-of-charge control for Lithium-Ion rechargeable batteries. The LM3420 is available in a sub-miniature 5-lead SOT23-5 surface mount package thus allowing very compact designs.

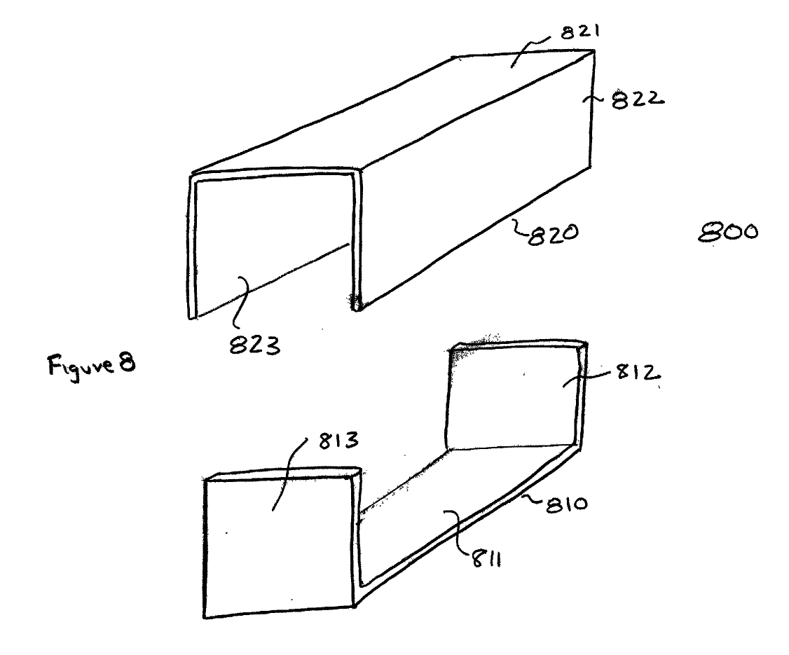

FIG. 8 shows an alternative view of a durable polymer structural casing 800 formed from two polymer batteries. Each polymer battery could be layers 101-105 as shown in FIG. 1, layers 201-207 as shown in FIG. 2, or any similar polymer battery. Starting with the exterior layer of the polymer battery, succeeding interior layers are nested inside, until the final layer is reached. Specific layering is not shown in FIG. 8, because this layering has been shown in detail in preceding FIGS. 3-7. Structural casing 800 includes lower-half structural casing battery 810 and upper-half structural casing battery 820. Lower-half structural casing 810 has base 811 and two structurally and electrically contiguous side walls 812 and 813. Upper-half structural casing 820 has top 821 and two structurally and electrically contiguous side walls 822 and 823. The interior surfaces of base 811, top 821, and the four contiguous sidewalls 812 and 813, as well as 822 and 823 form a cavity which encloses one or more electrical elements. Lower-half structural casing battery 810 and upper-half structural casing battery 820 may be electrically connected in series to provide additional voltage capacity or in parallel to provide additional current capacity.

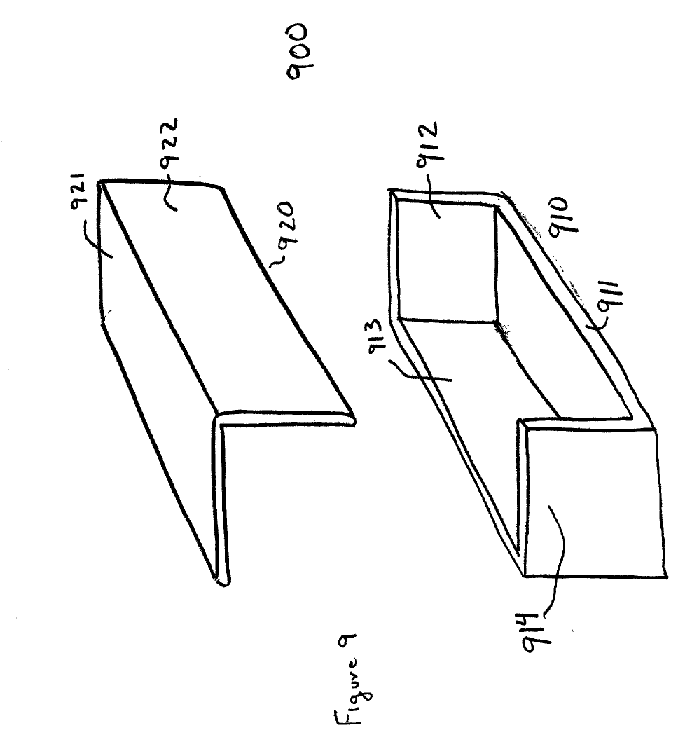

FIG. 9 shows yet another an alternative view of a durable polymer structural casing 900 formed from two polymer batteries. Each polymer battery could be layers 101-105 as shown in FIG. 1, layers 201-207 as shown in FIG. 2, or any similar polymer battery. Starting with the exterior layer of the polymer battery, succeeding interior layers are nested inside, until the final layer is reached. Specific layering is not shown in FIG. 9, because this layering has been shown in detail in preceding FIGS. 3-7. Structural casing 900 includes lower-half structural casing battery 910 and upper-half structural casing battery 920. Lower-half structural casing 910 has base 911 and three structurally and electrically contiguous side wall 912, 913, and 914. Upper-half structural casing 920 has top 921 and one structurally and electrically contiguous side wall 922. The interior surfaces of base 911, top 921, and the four contiguous sidewalls 912, 913, 914, and 922 form a cavity which encloses one or more electrical elements. Lower-half casing battery 910 and upper-half casing battery 920 may be electrically connected in series to provide additional voltage capacity or in parallel to provide additional current capacity. Furthermore, lower-half structural casing battery 910 and upper-half structural casing battery 920 can be interchanged, so that lower becomes upper and visa versa.

In FIGS. 3-9, the battery may be recharged while external power is provided to the electronics. This is practiced today, in laptop computers. Then, when external power is removed, either deliberately for mobile operations or by accident, during a power black out, the polymer batteries then supply the required power to the electronics. In FIGS. 3-9, the structural casing simultaneously provides mechanical durability, strength, and structural integrity as well as electrical power. Thus, a physically separate battery is not needed.

It should be noted that FIGS. 3 through 9 show generally rectangular box casings. In fact, only 3 sidewalls are needed to form a generally triangularly shaped cavity for both storing and providing power to electronics. More sidewalls could be used to provide other geometric shapes. For example, five sidewalls would form a generally pentagonal shaped cavity and six sidewalls would form a generally hexagonal shaped cavity. For ergonomic reasons, curvilinear surfaces such as ellipsoids, hemispheres, and domes could equally be used.

Additionally, the polymer battery shown in FIG. 1 and the durable polymer structural casings shown in FIGS. 3 through 9 could be augmented and further stiffened by adding the teflon support layers 201 and 207 which are shown in FIG. 2. A teflon layer could support negative electrode current collector layer 101 on the surface of negative electrode current collector layer 101 opposite to negative electrode layer 102. Another teflon layer could support positive electrode current collector layer 105 along the surface of positive electrode current collector layer 105 opposite to positive electrode layer 104. Instead of teflon, other nonconducting polymers, such as polycarbonate or acrylic, or epoxy could be used for these support layers.

While the invention has been shown and described with reference to a particular embodiment thereof, it will be understood to those skilled in the art, that various changes in form and details may be made therein without departing from the spirit and scope of the invention.

What I claim is:

1. A housing having a cavity for containing an electrical component, said housing comprising:
a base gel layer, said base gel layer having a cavity-side surface, an opposite side surface, and a perimeter having at least three edges;
three gel sidewalls, each of said gel sidewalls having a cavity side surface, an opposite side surface, and a lower edge, the lower edge of each of said gel sidewalls attached to the cavity side-surface of said base gel layer and along one of the edges of said base gel layer, the cavity-side surface of each of said gel sidewalls facing inwards, towards said cavity;
a cathode layer, said cathode layer having a gel surface and a cathode collector surface, the gel surface of said cathode layer in electrical contact with and generally conforming to the geometry of one of the surfaces of said base gel layer and said gel sidewalls;
an anode layer, said anode layer having a gel surface and an anode collector surface, the gel surface of said anode layer in electrical contact with and generally conforming to the geometry of the other surface of said base gel layer and said gel sidewalls;
a cathode collector, said cathode collector having a cathode surface which is in electrical contact with and generally conforming to the geometry of the cathode collector surface of said cathode layer; and
an anode collector, said anode collector having an anode surface which is in electrical contact with and generally conforming to the geometry of the anode collector surface of said anode layer.

2. The housing having a cavity for containing an electrical component, as in claim 1, further comprising:
said cathode layer is a metallic lithium layer;
said anode layer comprised of LiCoO₂, acetylene black, and binder; and
said base gel layer and said gel sidewalls comprised of a mixture of polyethylene oxide and polyvinylidene fluoride, the percent of polyethylene oxide is in a range of 25% to 60% by weight.

3. The housing having a cavity for containing an electrical component, as in claim 1, further comprising:
said cathode layer is poly-3,5 DFPT;
said anode layer is poly-3,4,5 TFPT;
said cathode collector is a 1 to 2 micrometer thick layer of carbon, said cathode layer having a cathode teflon surface opposite to the cathode surface;
a cathode teflon layer, said cathode teflon layer generally conforming with and supporting said cathode collector along the cathode teflon surface;
said anode collector is a 1 to 2 micrometer thick layer of carbon, said anode layer having an anode teflon surface opposite to the anode surface; and
an anode teflon layer, said anode teflon layer generally conforming with and supporting said anode collector along the anode teflon surface.

4. The housing having a cavity for containing an electrical component, as in claims 1, 2, or 3, further comprising:
each of said gel sidewalls having an upper edge, each upper edge opposite to the lower edge;
a cover, said cover having a perimeter having three edges, each of the edges generally aligned with one of the upper edges of said gel sidewalls, whereby said cavity is enclosed; and
said electrical component electrically connected with said anode collector layer and said cathode collector layer, whereby said housing provides mechanical durability, strength, and structural integrity as well as electrical power.

5. The housing having a cavity for containing an electrical component, as in claim 1, further comprising:
an opening, said opening allowing the use of a liquid crystal display.

6. The housing having a cavity for containing an electrical component, as in claim 1, further comprising:
an opening, said opening allowing the use of a push key for user input.

7. A housing having a cavity for containing an electrical component, said housing comprising:
a base gel layer, said base gel layer having a cavity-side surface, an opposite side surface, and a perimeter having an edges;
a gel sidewall having a cavity side surface, an opposite side surface, and a lower edge, the lower edge attached to the cavity side-surface of said base gel layer and along the edge of said base gel layer, the cavity-side surface of said gel sidewall facing inwards, towards said cavity;
a cathode layer, said cathode layer having a gel surface and a cathode collector surface, the gel surface of said cathode layer in electrical contact with and generally conforming to the geometry of one of the surfaces of said base gel layer and said gel sidewall;
an anode layer, said anode layer having a gel surface and an anode collector surface, the gel surface of said anode layer in electrical contact with and generally conforming to the geometry of the other surface of said base gel layer and said gel sidewall;
a cathode collector, said cathode collector having a cathode surface which is in electrical contact with and generally conforming to the geometry of the cathode collector surface of said cathode layer; and
an anode collector, said anode collector having an anode surface which is in electrical contact with and generally conforming to the geometry of the anode collector surface of said anode layer.

8. The housing having a cavity for containing an electrical component, as in claim 7, further comprising:
said cathode layer is a metallic lithium layer;
said anode layer comprised of LiCoO₂, acetylene black, and binder; and
said base gel layer and said gel sidewall comprised of a mixture of polyethylene oxide and polyvinylidene fluoride, the percent of polyethylene oxide is in a range of 25% to 60% by weight.

9. The housing having a cavity for containing an electrical component, as in claim 7, further comprising:
said cathode layer is poly-3,5 DFPT;
said anode layer is poly-3,4,5 TFPT;
said cathode collector is a 1 to 2 micrometer thick layer of carbon, said cathode layer having a cathode teflon surface opposite to the cathode surface;
a cathode teflon layer, said cathode teflon layer generally conforming with and supporting said cathode collector along the cathode teflon surface;
said anode collector is a 1 to 2 micrometer thick layer of carbon, said anode layer having an anode teflon surface opposite to the anode surface; and
an anode teflon layer, said anode teflon layer generally conforming with and supporting said anode collector along the anode teflon surface.

10. The housing having a cavity for containing an electrical component, as in claims 7, 8, or 9, further comprising:
said gel sidewall having an upper edge opposite to the lower edge;
a cover, said cover having a perimeter having an edge generally aligned with the upper edge of said sidewall, whereby said cavity is enclosed; and
said electrical component electrically connected with said anode collector layer and said cathode collector layer, whereby said housing provides mechanical durability, strength, and structural integrity as well as electrical power.

11. The housing having a cavity for containing an electrical component, as in claim 7, further comprising:
an opening, said opening allowing the use of a liquid crystal display.

12. The housing having a cavity for containing an electrical component, as in claim 7, further comprising:
an opening, said opening allowing the use of a push key for user input.

13. A housing having a cavity for containing an electrical component, said housing comprising:
a gel layer, said gel layer having a dome shape, a cavity-side surface, and an opposite side surface;
a cathode layer, said cathode layer having a gel surface and a cathode collector surface, the gel surface of said cathode layer in electrical contact with and generally conforming to the geometry of one of the surfaces of said gel layer;
an anode layer, said anode layer having a gel surface and an anode collector surface, the gel surface of said anode layer in electrical contact with and generally conforming to the geometry of the other surface of said gel layer;
a cathode collector, said cathode collector having a cathode surface which is in electrical contact with and generally conforming to the geometry of the cathode collector surface of said cathode layer; and
an anode collector, said anode collector having an anode surface which is in electrical contact with and generally conforming to the geometry of the anode collector surface of said anode layer.

14. The housing having a cavity for containing an electrical component, as in claim 13, further comprising:
said cathode layer is a metallic lithium layer;
said anode layer comprised of LiCoO₂, acetylene black, and binder; and
said gel layer is comprised of a mixture of polyethylene oxide and polyvinylidene fluoride, the percent of polyethylene oxide is in a range of 25% to 60% by weight.

15. The housing having a cavity for containing an electrical component, as in claim 13, further comprising:
said cathode layer is poly-3,5 DFPT;
said anode layer is poly-3,4,5 TFPT;
said cathode collector is a 1 to 2 micrometer thick layer of carbon, said cathode layer having a cathode teflon surface opposite to the cathode surface;
a cathode teflon layer, said cathode teflon layer generally conforming with and supporting said cathode collector along the cathode teflon surface;
said anode collector is a 1 to 2 micrometer thick layer of carbon, said anode layer having an anode teflon surface opposite to the anode surface; and an anode teflon layer, said anode teflon layer generally conforming with and supporting said anode collector along the anode teflon surface.
